(19) United States
(12) Patent Application Publication
(10) Pub. No.: US 2026/0311270 A1
(43) Pub. Date: Oct. 8, 2026

(54) Blockchain based Real Estate Compliance and Valuation Platform

(71) Applicant: Greg Woehrle, Lafayette, CA (US)

(72) Inventor: Greg Woehrle, Lafayette, CA (US)

(21) Appl. No.: 19/313,319

(22) Filed: Aug. 28, 2025

Related U.S. Application Data
(60) Provisional application No. 63/783,093, filed on Apr. 3, 2025.

(51) Int. Cl. G06Q 50/16; G06Q 30/018

(52) U.S. Cl. CPC G06Q 50/16; G06Q 30/018; G06Q 2220/00

(57) ABSTRACT

A system for generating and managing a unified property identifier and lifecycle record is disclosed. The system comprises a data ingestion module for receiving property data, including parcel identifiers and deed records. An artificial intelligence (AI) validation engine verifies the authenticity and completeness of the received data. A generation module creates a unique, blockchain-anchored universal property identifier based on the validated data. A physical tag with a machine-readable element is issued, which, when scanned, resolves to a digital property record. A smart contract platform deployed on a blockchain records property lifecycle events, such as permits and repairs, and dynamically updates a property score. The system also includes interfaces for transmitting validated data packets to counterparties, updating ownership information while preserving historical records, and enabling the creation and management of fractional ownership tokens cryptographically linked to the universal property identifier.

### CROSS-REFERENCE TO RELATED APPLICATIONS

The present application claims the benefit of U.S. Provisional Application No. 63/783,093, filed Apr. 3, 2025, by Greg Woehrle and titled “Blockchain based Real Estate Compliance and Valuation Platform”, included by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to systems and methods for the secure identification, lifecycle management, and value quantification of real estate parcels and their associated assets. The invention further relates to novel applications of blockchain technology, artificial intelligence (AI), dynamic valuation engines, and real-time property fingerprinting through a unified Unique Property Identifier (UPI) framework.

### BACKGROUND OF THE INVENTION

Property management systems (PMS) have evolved significantly over the past decade, integrating various technologies that improve how real estate assets are monitored, maintained, and managed. These platforms now encompass a wide range of functionalities, from lease tracking and maintenance scheduling to financial reporting and tenant communications. Modern property management systems offer web and mobile interfaces, enabling property owners, managers, and tenants to access information and conduct transactions seamlessly. Additionally, many systems incorporate data analytics, artificial intelligence (AI), and Internet of Things (IoT) devices to provide real-time insights into property conditions and operations.

One of the most prominent features of modern PMS is automated lease tracking and tenant management. These systems can manage multiple properties, automate rent collection, track lease renewals, and generate financial reports.

Most PMS platforms allow users to create, track, and manage work orders. Maintenance staff can receive alerts via mobile devices, reducing response times for repairs. Some systems also include predictive maintenance features that track the lifecycle of appliances or building systems and provide alerts when replacements or repairs are needed.

Integrated accounting features in PMS platforms allow property managers to manage budgets, track expenses, and generate detailed financial reports. These systems can also automate tax filings and track vendor payments, improving financial transparency. With the rise of smart building technologies, many property management systems integrate IoT devices that monitor energy consumption, temperature, security, and other key factors. These integrations enable real-time energy management and reduce costs, improving operational efficiency and sustainability.

Property management platforms increasingly integrate tools that track regulatory compliance related to safety inspections, zoning laws, and environmental regulations. This feature helps ensure that properties meet legal standards, reducing the risk of violations. Despite these advancements, modern property management systems face several challenges and deficiencies.

The global real estate system suffers from a fundamental lack of standardized, interoperable, and tamper-resistant property identity frameworks. Property data is fragmented across government databases, title companies, permitting offices, appraisal networks, and private platforms. No universal method currently exists for verifying the true identity, condition, and lifecycle state of a physical property or its associated improvements in real time.

Many property management systems struggle with data silos, where property data is spread across multiple platforms, making it difficult to integrate and analyze holistically. This fragmentation can hinder decision-making and reduce the system's overall efficiency. Current systems may lack the level of transparency necessary to provide real-time verification of property conditions or transactions. For example, while PMS platforms can track maintenance tasks, they often do not provide real-time, verifiable proof that repairs were completed or that a property remains compliant with regulations.

Property data is often captured in varying formats across different platforms, leading to inconsistencies in how property health, maintenance, and energy efficiency are measured. This can create barriers for stakeholders when comparing properties or making investment decisions.

Although many systems offer predictive maintenance, they often fall short of providing truly holistic, forward-looking insights into a property's overall health. Current systems may fail to incorporate a wide enough range of factors—such as environmental conditions, structural integrity, and market trends—limiting their ability to provide accurate predictions regarding property longevity or maintenance needs. Existing solutions for property management often involve Property Management Systems (PMS) that have evolved to integrate technologies for monitoring, maintaining, and managing real estate assets1. These systems commonly feature web and mobile interfaces, enabling access to information and transactions Functionalities include automated lease tracking and tenant management, automating rent collection, tracking lease renewals, and generating financial reports. Many platforms also allow users to create, track, and manage work orders, enabling maintenance staff to receive mobile alerts to reduce response times.

Traditional identifiers such as parcel numbers (APNs), deed references, and street addresses are incomplete, non-standardized, and susceptible to error, duplication, or fraud. These identifiers do not contain embedded verification capabilities, nor do they track lifecycle changes, risk states, emotional or environmental impact, or digital ownership rights. Beyond traditional PMS, the real estate sector also utilizes various data sources and systems, including public records for tax data, building permits, and zoning information, and Geographic Information System (GIS) data for spatial coordinates and land use insights. Private data sources contribute metrics like energy efficiency from utility companies or smart home systems, and appliance and maintenance records from contractors or property management software. Industry standards like RESO UPI exist as a standard identifier for MLS data standardization. Data aggregation systems collect extensive property data. Some blockchain-based systems have been introduced using the Bitcoin blockchain for property ownership recording.

Despite advancements, modern property management systems face significant challenges and deficiencies. One major issue is data silos, where property data is fragmented and spread across multiple platforms. This fragmentation makes it difficult to integrate and analyze data holistically, hindering effective decision-making and reducing overall system efficiency. Data is often captured in varying formats across different platforms, leading to inconsistencies in measuring property health, maintenance, and energy efficiency, which creates barriers for stakeholders comparing properties or making investment decisions. As a result, property buyers, lenders, insurers, appraisers, contractors, and regulatory bodies face substantial friction when verifying, underwriting, scoring, transacting, or improving physical properties. There is no single, reliable, and secure method for confirming a property's physical status, compliance standing, or transactional readiness.

Furthermore, current systems frequently lack the necessary transparency for real-time verification of property conditions or transactions. While they might track maintenance tasks, they often fail to provide real-time, verifiable proof that repairs were completed or that a property remains compliant with regulations. Traditional appraisals, for instance, are static snapshots of value that quickly become outdated, rather than reflecting a property's current condition dynamically. This lack of transparency and verifiable data leads to low consumer trust in property information.

Many existing processes are also characterized by manual verification, human error, inefficiencies, and significant delays. Traditional real estate records and transactions heavily rely on static databases and manual checks. Processes like government interoperation are often slow and redundant. Existing systems can involve human chokepoints, particularly in financial sectors like mortgages. This reliance on manual processes contributes to inefficiencies and risks, and existing systems often lack the real-time adaptability needed in a dynamic market. Furthermore, current digital real estate platforms are passive record repositories, not active, intelligent, and interoperable systems. They lack blockchain validation, real-time scoring, smart contract enforceability, and integrations with permitting or financial systems.

Existing blockchain-based real estate solutions, while introducing immutability and decentralization, often have limited scope and lack integration of key features. For example, some prior patents for blockchain property records lack AI-driven valuation lifecycle tracking or interoperability between government, financial, and decentralized registries. Existing real estate AI models may fail to incorporate automated property health tracking from sensors or smart contract-enforced compliance monitoring. Current systems do not describe a system with the comprehensive suite of elements, specifically AI validation, physical tag issuance, or defined tokenization for physical real estate.

Security risks and vulnerability to fraud are also significant problems in traditional systems. The reliance on static databases and manual verification processes makes these systems less resistant to fraud. While some modern systems might detect anomalies, the fundamental identity layer and historical records are not always tamper-proof or universally verifiable. Without a truly immutable and universally recognized identifier tied to the physical asset, proving the authenticity and integrity of property data remains a challenge.

Finally, traditional and even many modern systems struggle to provide holistic, forward-looking insights. They may focus on a limited range of metrics and fall short of providing truly holistic, predictive maintenance alerts. The inconsistent data formats across platforms exacerbate this, making it difficult to build comprehensive property health profiles. Existing systems often lack the predictive intelligence needed to forecast property longevity or maintenance needs effectively. Furthermore, there is a lack of a unified identifier that dynamically tracks the entire property lifecycle and provides a scannable interface for easy access to this evolving data. There is a critical market need for a universal, real-time authentication and lifecycle management platform that transforms every property into a live, verified, intelligent digital asset-capable of being scanned, scored, analyzed, tokenized, insured, financed, and transferred with trust, speed, and precision.

It is therefore an objective of the present invention to provide a comprehensive, blockchain-backed system for the secure identification, lifecycle management, and value quantification of real estate parcels and their associated assets, integrating blockchain technology, AI, dynamic valuation engines, and real-time property fingerprinting through a unified identifier framework to address the deficiencies of existing property management systems.

### SUMMARY OF THE INVENTION

In one aspect, a real estate information management system is disclosed. The system comprises several interconnected modules designed to collectively manage property data from ingestion to presentation.

The system includes a data ingestion module. This module is configured to receive various types of property data. Specifically, it receives “core property data” which serves to identify a specific property. Such core property data may include, but is not limited to, an Assessor's Parcel Number (APN), a Geographic Information System (GIS) Parcel ID, a Tax ID, or a physical property address. The data ingestion module also receives “supplemental property data” which identifies various characteristics of the property. This supplemental data can encompass documents like inspection reports, appraisals, or ongoing updates related to the physical condition or legal status of the property. Furthermore, the data ingestion module is configured to obtain “ancillary property data” from various external sources. These external sources can include government agencies, public records databases, commercial property databases, multiple listing services (MLS), and data feeds from sensors such as Internet of Things (IoT) devices, drones, or satellites. The ancillary data provides additional characteristics of the property, such as deed records, zoning information, or permit history. The data ingestion module may employ mechanisms like data connectors, Application Programming Interfaces (APIs), or web scraping techniques to obtain this ancillary data.

Operatively coupled to the data ingestion module is a data validation module. This module is responsible for processing the ingested data to ensure its quality and consistency. It is configured to clean and normalize a “collective property dataset,” which comprises the core, supplemental, and ancillary property data. This normalization process includes transforming the collective property dataset into a unified schema, making it consistent for further processing and storage. The data validation module analyzes the dataset in this unified schema to detect conflicting entries. Upon detection of such conflicts, portions of the dataset determined to be incorrect are removed or discarded. In some embodiments, this conflict detection and resolution process involves an Artificial Intelligence (AI) model. This AI model assesses a detected conflict and generates a conflict confidence score, which indicates the severity of the conflict. This score is based on factors such as the credibility of the data source, the timestamp associated with the conflicting data, and lifecycle statistics of the property. If this conflict confidence score exceeds a predefined threshold, the conflicting data portion is deemed incorrect and is removed.

The data validation module also analyzes the collective property dataset to detect anomalies, and any detected anomalies are flagged for review or further action. For instance, it can be configured to detect unpermitted or unauthorized property modifications by comparing data within the collective dataset with data obtained from external sources like Light Detection and Ranging (LIDAR) scans, drone imagery, satellite imagery, or the output of computer vision analysis performed on such imagery. Furthermore, the data validation module calculates a confidence score for the collective property dataset in its unified schema, providing an indication of the overall reliability of the data. This confidence score is dynamically updated whenever there is an update to the collective property dataset.

The system further comprises a primary or universal property identifier generation module. This module is configured to create a unique digital identity for the property. It achieves this by hashing the core property data to create a primary or “universal property identifier” (UPI). Once generated, this module submits the universal property identifier and the validated collective property dataset (in its unified schema, from the data validation module) to a smart contract. It also submits the universal property identifier to a universal property identifier tag issuance module.

A smart contract is a component of the system, configured to operate on a blockchain. This smart contract receives the universal property identifier and the associated collective property dataset in its unified schema from the UPI generation module. Its primary function is to record this universal property identifier and the property dataset onto the blockchain, thereby creating an immutable and verifiable record. In some configurations, the blockchain may comprise a main blockchain and at least one side-chain, with the smart contract utilizing both for recording the data. The smart contract can also be configured to store or reference larger files associated with the property dataset using off-chain storage solutions, such as traditional cloud storage or decentralized storage systems like the InterPlanetary File System (IPFS).

The system also includes a universal property identifier tag issuance module. This module receives the universal property identifier from the UPI generation module. It then generates a “machine readable artifact.” This artifact is designed to embed a dynamic data pointer that links directly to the recorded collective property dataset (in its unified schema) stored on the blockchain. This machine readable artifact is typically scannable and can take various forms, such as a Quick Response (QR) code, a Near Field Communication (NFC) tag, or a scannable sticker that can be physically affixed to the property. To enhance its reliability and security, the machine readable artifact may incorporate security features like a holographic pattern or embedded data redundancy features.

Finally, the system includes an interface module. This module is configured to present the recorded collective property dataset (in its unified schema) from the blockchain. It does so in response to requests that are made via the dynamic data pointer embedded in the machine readable artifact. This allows authorized users or systems to access the property information by interacting with the physical tag.

Optionally, the system may further comprise a valuation module. This module is configured to assess the recorded collective property dataset in its unified schema and generate a valuation score for the property. In some embodiments, this valuation module comprises an AI model specifically configured to generate this valuation score based on the comprehensive property data.

Additionally, the system can include a governance module. This module may incorporate an AI model designed to dynamically orchestrate various system operations. These operations can include managing lifecycle events for the property, conducting compliance readiness assessments related to the property, triggering updates to the property's valuation score, and managing inter-system communications that involve data associated with the property. In another aspect, a computer-implemented method for real estate information management is disclosed, mirroring the functionalities of the system described above.

The method begins with receiving core property data identifying a property, receiving supplemental property data identifying characteristics of the property, and obtaining ancillary property data from external sources that identify additional characteristics. These steps are typically performed by a data ingestion module executed by one or more processors. The core property data may include identifiers like APN, GIS Parcel ID, Tax ID, or a physical address. Supplemental data can include inspection reports or appraisals. Ancillary data, sourced from government agencies, public records, commercial databases, MLS, or sensors (IoT, drones, satellites) via data connectors, APIs, or web scraping, can include deed records, zoning, or permit history.

Following data collection, the method involves cleaning and normalizing a collective property dataset (comprising the core, supplemental, and ancillary data) and transforming it into a unified schema. This is executed by a data validation module. The method then proceeds to analyze this dataset in its unified schema to detect conflicting entries, with portions determined to be incorrect being removed. This conflict analysis may involve using an AI model to assess conflicts, generate a conflict confidence score (based on source credibility, timestamps, lifecycle stats), and remove data if the score exceeds a threshold. The method also includes analyzing the dataset to detect anomalies (such as unpermitted modifications, identified by comparing property data with LIDAR, drone, or satellite imagery) and flagging them. A confidence score for the dataset is calculated and subsequently updated whenever the property data changes.

Next, the method comprises hashing the core property data to create a universal property identifier therefrom. This UPI and the validated collective property dataset (in unified schema) are then submitted to a smart contract, and the UPI is also submitted to a universal property identifier tag issuance module. These actions are performed by a UPI generation module.

The smart contract, executed on a blockchain, then receives the UPI and the property dataset and records them on said blockchain. This blockchain may involve a main chain and side-chains, and the smart contract may reference larger files on off-chain storage (cloud or decentralized systems like IPFS).

The universal property identifier tag issuance module receives the UPI and generates a machine readable artifact. This artifact, which can be a scannable QR code, NFC tag, or sticker with security features like holographic patterns or redundancy, embeds a dynamic data pointer to the recorded property data on the blockchain. Finally, an interface module presents the recorded property data from the blockchain in response to requests made via the dynamic data pointer in the machine readable artifact.

The method may further include assessing the recorded property dataset and generating a valuation score for the property, potentially using an AI model within a valuation module. It can also involve dynamically orchestrating system operations (lifecycle events, compliance, valuation triggers, inter-system communications) using a governance module that includes an AI model.

This system and method provide an approach to creating a trusted, dynamic, and easily accessible digital record for real estate properties, addressing many of the inefficiencies and data fragmentation issues prevalent in the industry.

### BRIEF DESCRIPTION OF THE DRAWINGS

A complete understanding of the present invention may be obtained by reference to the accompanying drawings, when considered in conjunction with the subsequent detailed description.

FIG. 1 is a block diagram of the system.

FIG. 2 is block diagram of system components.

FIG. 3 is a block diagram of the data processing pipeline components.

FIG. 4 is a detailed block diagram of the system.

FIG. 5 is a block diagram of external source components.

FIG. 6 is a block diagram of user submitted data types.

FIG. 7 is a block diagram of external data source types.

FIG. 8 is a block diagram of the data validation module.

FIG. 9 is a block diagram of the data validation module.

FIG. 10 is a block diagram including the blockchain module.

FIG. 11 is a block diagram of the machine readable tag.

FIG. 12 is a block diagram including the valuation score output.

FIG. 13 is a block diagram including the governance module.

FIG. 14A is a flowchart illustrating the data ingestion and data validation process.

FIG. 14B is a continuation of the flowchart from FIG. 14A illustrating the data ingestion and data validation process.

FIG. 15A is a flowchart illustrating the UPI generation process, tag issuance process and blockchain interaction.

FIG. 15B is a continuation of the flowchart from FIG. 15A illustrating the UPI generation process, tag issuance process and blockchain interaction.

FIG. 16 is a flowchart illustrating authentication features.

FIG. 17 is a block diagram of the system valuation features

FIG. 18 is a flowchart visualization features.

FIG. 19 is a block diagram illustrating integration features.

FIG. 20 is a flowchart illustrating the identity features.

FIG. 21 is a block diagram of a system.

FIG. 22 is a block diagram of a system interacting with a network.

FIG. 23 is a block diagram of a system interacting with a blockchain.

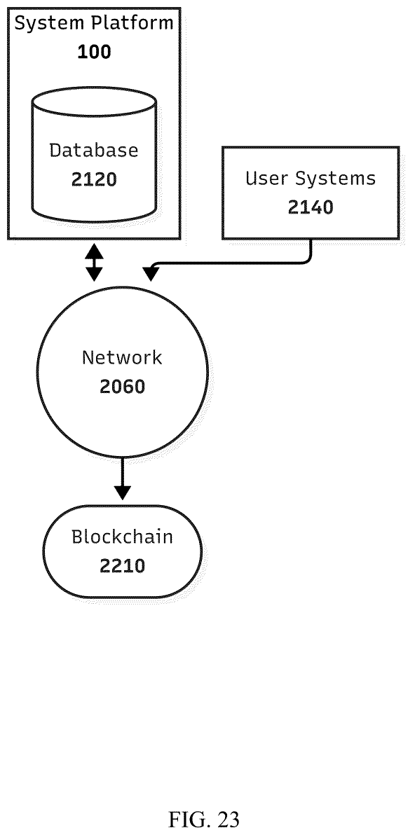

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

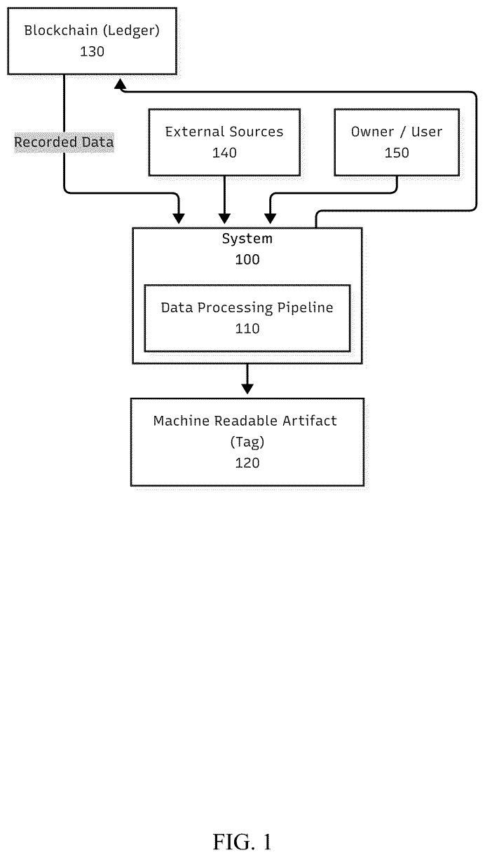

Turning now to FIG. 1, shown is the overall architecture of the real estate information management system 100. The system 100 serves as the central processing hub for the invention, taking in raw data from various sources and producing a verifiable digital record anchored to a physical artifact. The system 100 receives data from two primary categories of external inputs. The first is external sources 140, which represents a plurality of third-party databases and data providers. These can include, but are not limited to, government agencies (such as county recorders and tax assessors), public records databases, commercial real estate data aggregators, Multiple Listing Services (MLS), and data feeds from sensors such as IoT devices or satellite imagery. The second category of input is the owner/user 150, representing direct data submission from an individual with knowledge of the property, such as the legal owner or their designated agent. This user-submitted data can include private documents, inspection reports, or recent updates not yet available in public records.

Contained within the system 100 is the data processing pipeline 110. This internal pipeline represents the series of modules responsible for executing the core logic of the invention, including the data ingestion module, the data validation module, and the universal property identifier generation module. The data processing pipeline 110 is responsible for cleaning, normalizing, validating, and transforming the inbound data from sources 140 and 150 into a unified and trusted dataset.

The system 100, via its data processing pipeline 110, interacts with the blockchain 130 illustrating the process of recording the validated property data and its associated universal property identifier onto the immutable ledger. This creates a permanent, tamper-evident record. Conversely, the system reads from the blockchain to access previously recorded data. This allows the system to verify information, track historical changes, and present the most current, authoritative state of the property's record. The system 100 also interacts with external sources 140 to retrieve data for the purpose of validating data already present on the blockchain 130.

A primary output of the system 100 is the machine readable artifact (tag) 120. After processing the data and generating a universal property identifier, the system 100 generates this artifact. The tag 120 is a physical or digital object, such as a QR code, sticker, holographic sticker or NFC tag, that contains a pointer to the property's record on the blockchain 130. It serves as the physical-to-digital bridge, allowing anyone with the appropriate authorization to scan the tag and access the verified property information managed by the system 100.

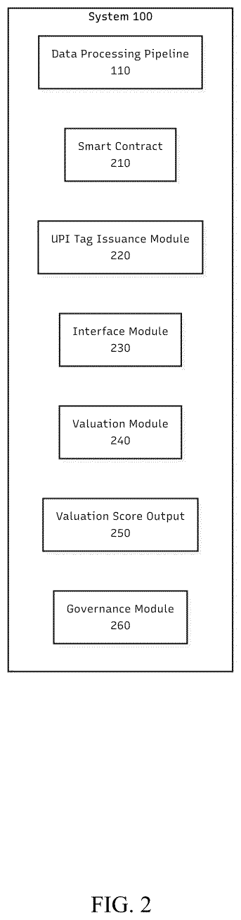

Turning now to FIG. 2 provides a more granular view of the functional components that make up the real estate information management system 100. These modules work in concert to process data, manage the blockchain record, issue artifacts, and provide advanced analytical and governance capabilities. The process begins with the data processing pipeline 110, which as described in FIG. 1, is responsible for the initial ingestion, validation, normalization, and processing of all inbound property data. It is the engine that transforms raw data inputs into a trusted, unified dataset and generates the universal property identifier (UPI).

The output of the data processing pipeline 110, namely the validated property dataset and the UPI, is then passed to the smart contract 210. The smart contract 210 is a programmable component deployed on a blockchain. Its primary function is to receive the validated data and immutably record it on the ledger, creating a permanent and verifiable entry associated with the property's UPI. The UPI tag issuance module 220 also receives the UPI from the data processing pipeline 110. This module is configured to generate the machine-readable artifact, or tag, for the physical property. It embeds a dynamic data pointer within this tag that links directly to the property's record on the blockchain as managed by the smart contract 210.

The interface module 230 serves as the presentation layer for the system. It is responsible for handling incoming requests that are initiated by accessing the dynamic data pointer on the machine-readable artifact. Upon receiving a request, the interface module 230 retrieves the relevant data from the blockchain and presents it to the user or requesting system in a human-readable format. The system 100 may also include several optional, advanced modules. The valuation module 240 is an analytical component that assesses the comprehensive, validated property dataset to calculate a dynamic valuation for the property. This module may utilize an artificial intelligence (AI) model to weigh various factors such as lifecycle events, market data, and physical characteristics.

The output of the valuation module 240 is the valuation score output 250. This is the calculated score or assessment that represents the property's condition, risk, or market value at a given point in time. This score can be presented to users through the interface module 230. Finally, the governance module 260 represents a high-level orchestration layer within the system 100. This module, often comprising an AI model, monitors the entire system for new events, data updates, or external triggers. It can dynamically manage and orchestrate the actions of other modules, such as initiating a re-validation of data, triggering a new valuation, or managing inter-system communications based on a predefined set of rules and logic.

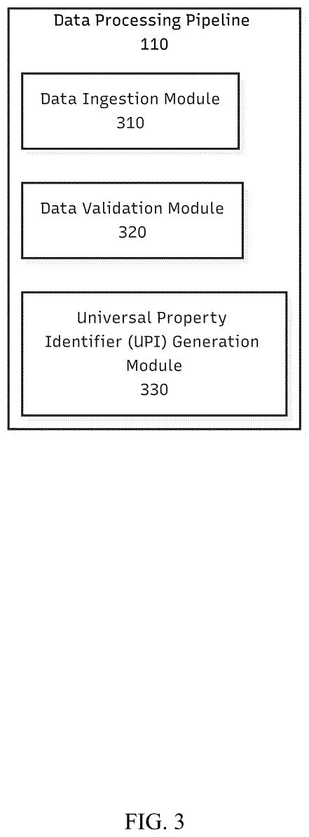

Turning now to FIG. 3, shown is a block diagram that provides a detailed view of the data processing pipeline 110, in accordance with one embodiment. This diagram illustrates the sequential sub-modules that handle the transformation of raw property data into a validated dataset and a unique identifier. The process begins with the data ingestion module 310. This module serves as the initial entry point for all property-related information into the system. It is configured to receive data from a plurality of sources, including but not limited to direct user submissions, public records databases, and third-party data feeds via APIs. The data ingestion module 310 gathers the core, supplemental, and ancillary data and aggregates it into a raw, collective dataset, which is then passed to the next stage of the pipeline.

Following ingestion, the raw dataset is processed by the data validation module 320. This module is responsible for ensuring the quality, accuracy, and integrity of the property data. It performs several key operations, such as cleaning the data to correct formatting errors, normalizing the data into a unified schema for consistent processing, analyzing the data to detect and resolve conflicts between different sources, and identifying and flagging anomalies that may indicate errors or fraudulent information. The output of this module is a cleaned, validated, and trustworthy property dataset.

The final stage of the data processing pipeline 110 is the universal property identifier (UPI) generation module 330. This module receives the validated property dataset from the data validation module 320. Its primary function is to create a unique and persistent digital identifier for the property. It does so by taking the most essential core property data (such as the parcel number) from the validated dataset and applying a cryptographic hashing algorithm to it, thereby generating the UPI. The UPI generation module 330 then outputs this UPI along with the full validated dataset, which are subsequently passed to other components of the system 100 (such as the smart contract and the UPI tag issuance module) for blockchain recordation and artifact creation.

In one embodiment of the invention, the data validation module 320 corresponds to an AI-powered validation engine which performs several key operations. It performs data cleaning and normalization. It first cleans the aggregated data to correct formatting errors, handle missing values, and remove inconsistencies. It then normalizes the data, transforming it into a unified schema. This standardization is important for consistent and accurate processing, comparison, and storage, regardless of the original source or format of the data. It performs conflict and anomaly detection; the module employs advanced algorithms, including artificial intelligence and machine learning models, to analyze the unified dataset. It cross-references data points from different sources to detect conflicting entries (e.g., different square footage figures from a tax record versus an appraisal) and analyzes patterns to identify anomalies that may indicate errors, unrecorded modifications, or potentially fraudulent information. Conflicting entries that are determined to be incorrect are discarded or flagged for manual review. It performs confidence scoring. Based on the results of the validation, conflict, and anomaly checks, the data validation module 320 calculates a confidence score for the property's dataset. This score quantifies the system's trust in the overall accuracy and completeness of the data. Factors influencing this score can include the authoritativeness of the data sources, the number of corroborating sources, and the age of the data. This score is dynamic and is updated as new information is processed. The output of this module is a cleaned, validated, and trustworthy property dataset with an associated confidence score.

The universal property identifier (UPI) generation module 330 receives the validated property dataset from the data validation module 320. Its primary function is to create a unique and persistent digital identifier for the property. To do this, it typically takes the most essential and stable core property data (such as the parcel number) from the validated dataset and applies a cryptographic hashing algorithm to it, thereby generating the unique UPI. The UPI generation module 330 then outputs this UPI along with the full validated dataset, which are subsequently passed to other components of the system for blockchain recordation and the creation of a scannable, machine-readable artifact.

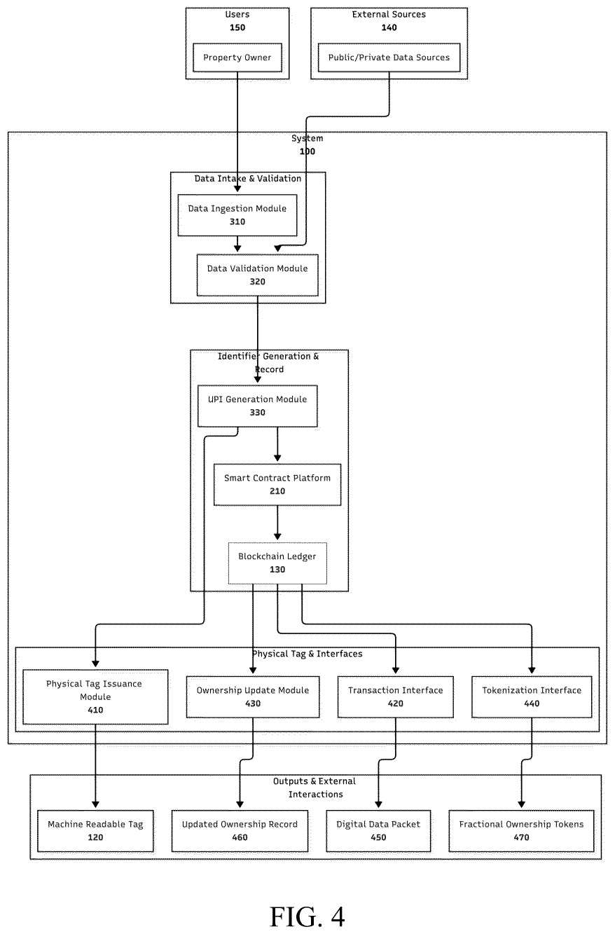

Turning now to FIG. 4, provided is a comprehensive overview of the architecture of the real estate information management system 100. The diagram is divided into sections representing external inputs, the core system 100, and the system's outputs and external interactions. The process begins with external inputs from users 150 and external sources 140. Users 150, such as a property owner or agent, interact with the system 100 to submit property data. This can include core and supplemental property information. Concurrently, the system 100 interacts with external sources 140, such as public and private databases, which are used for verification of the submitted and existing property data.

Within the main system 100, the first block is data Intake & Validation. This block contains the data ingestion module 310, which receives the inputs, and the data validation module 320, which processes, cleans, and validates the data. The output of this block is the validated property data. The validated property data is then fed into the Identifier Generation & Record block. Here, the UPI generation module 330 uses the validated data to create a unique property identifier (UPI). The module then outputs the UPI & validated data to the smart contract platform 210. The smart contract platform 210 executes the logic to records data onto the blockchain 130, creating an immutable and verifiable record of the property's identity and its associated data.

The UPI generation module 330 also provides the UPI to the Physical Tag & Interfaces block. This block contains several modules that interact with the central blockchain. The physical tag issuance module 410 receives the UPI and generates a physical artifact. Ownership update module 430 interacts with the blockchain, as indicated by the “Is Updated By” relationship, to modify ownership records upon a property transfer. Transaction interface 420 interacts with the blockchain 130, as indicated by the “Reads Data For” relationship, to retrieve validated information for creating data packets. Tokenization interface 440 interacts with the blockchain 130, as indicated by the “Is Linked To By” relationship, to create and manage digital tokens tied to the property's UPI.

Finally, the modules in the Physical Tag & Interfaces block produce the Outputs & External Interactions. The physical tag issuance module 410 generates the machine readable artifact or tag 120. The ownership update module 430 results in an updated ownership record 460, reflecting a transfer of ownership. The transaction interface 420 generates a digital data packet 450 for sharing with third parties like lenders. The tokenization interface 440 creates fractional ownership tokens 470, which can be managed and traded by investors. In this manner, FIG. 4 illustrates the end-to-end process of the system, from collecting and validating disparate property data to creating a secure, blockchain-anchored digital identity that supports various downstream applications such as physical tagging, ownership transfers, transactional due diligence, and asset tokenization.

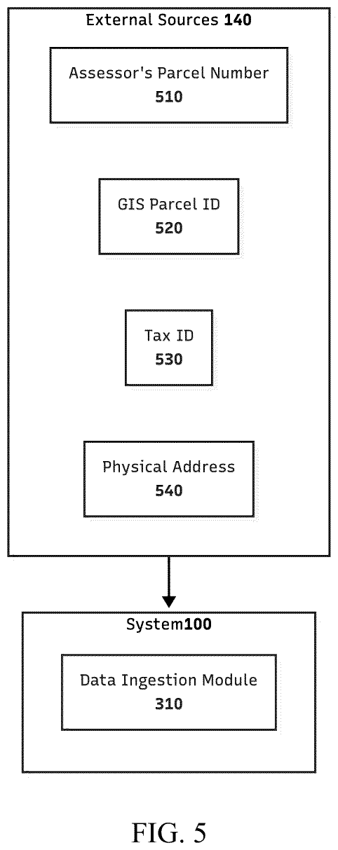

Turning now to FIG. 5 is a block diagram illustrating various examples of external sources 140 that provide the core property data to the data ingestion module 310 of the system 100, in accordance with one embodiment. This core data consists of foundational identifiers that are essential for uniquely identifying a specific physical real estate asset. FIG. 4 shows a block representing external sources 140, which encompasses a plurality of authoritative data repositories. Within this block, several specific examples of core identifiers are shown. These include the Assessor's Parcel Number (APN) 510, which is a unique number assigned to parcels of property by a jurisdiction's tax assessor for identification and record-keeping purposes. Also included is the GIS Parcel ID 520, which is a unique identifier associated with a property's geospatial data within a Geographic Information System, defining its precise location and boundaries. The Tax ID 530 represents another identifier used by governmental bodies for taxation purposes. Finally, the physical address 540 is the common street address for the property.

These individual data points (510, 520, 530, and 540) are collectively referred to as the core property data. This core property data flows from the external sources 140 into the main system 100. Specifically, the data is received and processed by the data ingestion module 310, which is the initial component of the system's data processing pipeline. This ingestion of verified, foundational identifiers is the critical first step in the process, as this core property data will be used in subsequent steps by the UPI generation module to create the unique and immutable Universal Property Identifier for the asset.

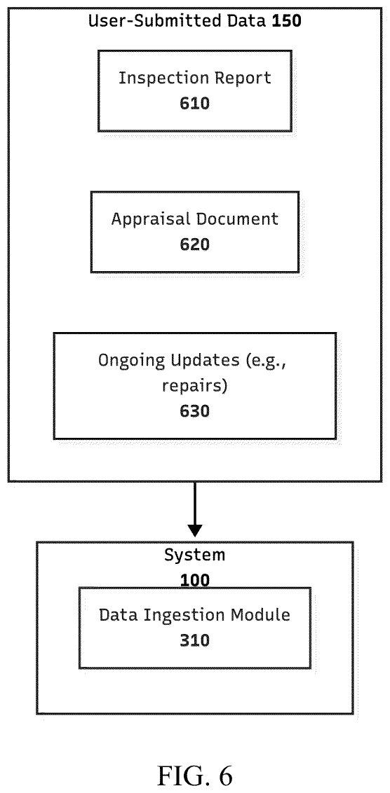

Turning now to FIG. 6, provided is a detailed illustration of another data input channel for the system, focusing specifically on the acquisition of supplemental property data from sources of user-submitted data 150. This category of data is distinct from the core identifiers typically obtained from authoritative external sources and originates from the property owner, their designated agent, or another party with direct knowledge of and access to the property and its related documentation.

The diagram shows a block representing user-submitted data 150, which encompasses a plurality of data types that a user can provide to the system. Within this block, several specific examples of supplemental data are shown such as an inspection report 610 represents a formal document typically prepared by a professional home inspector. This report details the condition of the property's structure, major systems (such as plumbing, electrical, and HVAC), and other components. This data provides a detailed snapshot of the property's physical health at a specific point in time, which is valuable for valuation and disclosure. Also, an appraisal document 620 represents a professional appraiser's official opinion of the market value of the property. This document generally includes a detailed analysis of the property itself, its features, and comparable sales data for similar properties in the area, providing key financial and valuation information. Finally, ongoing updates (e.g., repairs) 630 represents a broader category of dynamic information that reflects changes to the property over time. This can include, for example, receipts for recent repairs, documentation of renovations or upgrades, utility bills, or notifications about changes in the property's legal status (e.g., placement in a trust). This data is often timely and not yet available in public records. Collectively, these user-submitted items (610, 620, and 630) constitute the supplemental property data. As illustrated, this supplemental property data flows from the user-submitted data 150 source into the main system 100. Specifically, the data is received and processed by the data ingestion module 310, which is the initial component of the system's data processing pipeline.

The ingestion of this supplemental data is vital for creating a comprehensive and up-to-date digital record, as it provides timely and detailed information that enriches the property profile beyond what is available from public records or other automated external databases. This data is subsequently processed and validated by the data validation module to ensure its integrity before being incorporated into the property's official digital record.

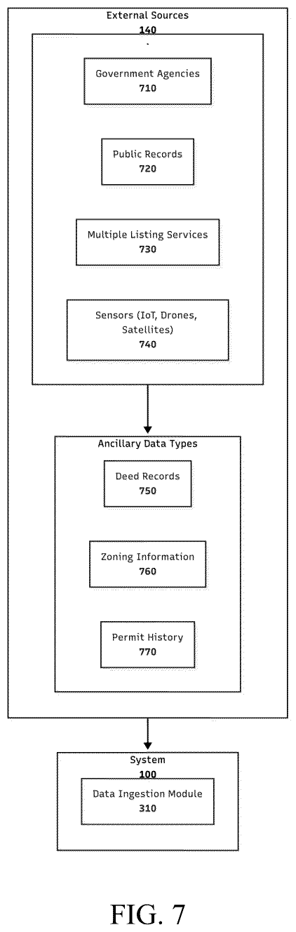

Turning now to FIG. 7, provided is a detailed illustration of a third data input channel for the system, focusing specifically on the acquisition of ancillary data from a wide range of automated and external data providers. This category of data complements the core and supplemental data by providing a broad set of historical, legal, and environmental characteristics of the property.

The diagram shows a primary block representing external sources 140, which encompasses a plurality of institutional and technological data providers. Within this block, several specific examples of these sources are detailed. Government agencies 710 include municipal, county, state, and federal bodies that maintain official records related to property, such as planning departments, tax assessors, and environmental agencies. Public records 720 represent publicly accessible databases that may contain a variety of information pertinent to a property, including legal filings, ownership history, and other recorded documents. Multiple Listing Services 730 are proprietary databases used by real estate professionals that contain detailed information about property listings, sales history, and market data. Sensors (IoT, Drones, Satellites) 740 represent a modern category of data sources that can provide real-time or near-real-time information about the physical state and environment of the property. This includes data from Internet of Things (IoT) devices on or near the property, high-resolution imagery from drones, and geospatial or environmental data from satellites.

These various external sources 140 are the originators of different ancillary data types. The diagram shows several non-limiting examples of such data types that can be obtained from these sources, including deed records 750 which are official legal documents that record the transfer of ownership of the property, zoning information 760 which includes data from municipal planning departments that specifies the permissible uses of the land (e.g., residential, commercial), and permit history 770 providing a record of all building and renovation permits issued for the property, providing a history of modifications and improvements.

As illustrated by captioned “via Connectors, APIs, Web Scraping,” the system employs various technical mechanisms to obtain the ancillary data types from the external sources 140. These mechanisms can include direct, secure connections through application programming interfaces (APIs), the use of dedicated data connectors, or automated web scraping techniques to extract relevant information from public-facing websites or databases.

Finally, this ancillary data, having been obtained through these mechanisms, flows into the main system 100, where it is received and processed by the data ingestion module 310. The ingestion of this rich ancillary data is essential for the data validation module to perform comprehensive cross-referencing and verification, ultimately contributing to a robust and trustworthy digital record for the property.

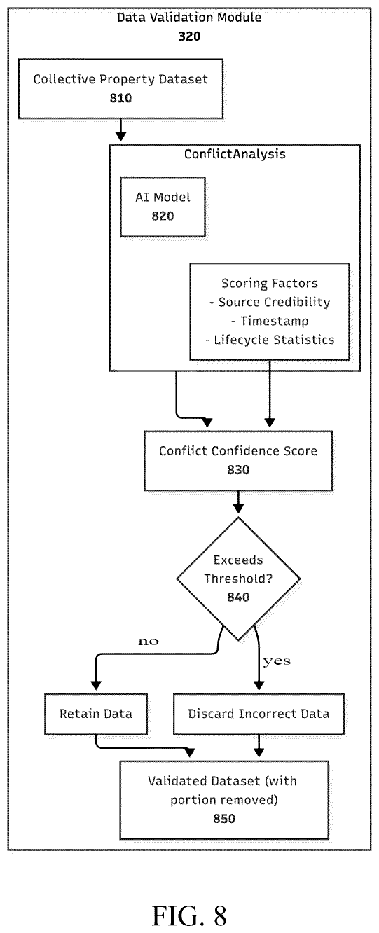

Turning now to FIG. 8, provided is a detailed view of the conflict resolution logic within the data validation module 320. This process is designed to ensure the integrity of the property data by systematically identifying and resolving discrepancies that may arise from aggregating information from multiple, varied sources. The process begins with the collective property dataset 810 as its input. This dataset, having been ingested and normalized into a unified schema, is fed into the conflict analysis stage.

The conflict analysis is an intelligent process that utilizes an AI model 820. This AI model is trained to recognize and evaluate inconsistencies within the property data. For example, it can identify discrepancies in ownership records, property size, or permit status between different source documents. When the AI model 820 assesses conflict, it uses a set of predefined scoring factors to evaluate the severity and likely cause of the discrepancy. These factors can include, but are not limited to, the source credibility (e.g., data from a government agency may be weighted more heavily than user-submitted data), the timestamp of the data (more recent data may be more accurate), and lifecycle statistics of the property (e.g., a recent sale might explain a change in ownership data).

Based on this assessment, the process is used to generate a conflict confidence score 830. This score is a quantitative measure representing the system's confidence that a particular piece of conflicting data is incorrect. The conflict confidence score 830 is then compared against a predefined threshold 840. If the score does not exceed the threshold, it indicates that the conflict is minor or that there is insufficient evidence to invalidate any of the data. In this case, the system proceeds to retain data, and the original data passes through to the next stage. If the score does exceed the threshold, it indicates a high probability that a specific piece of data is erroneous. In this case, the system proceeds to discard incorrect data, removing the flagged, low-confidence portion from the dataset. The output of this decision process is the validated dataset (with portion removed) 850. This resulting dataset has been vetted for internal consistency, with identified conflicts having been resolved, thereby increasing the overall trustworthiness and reliability of the property's digital record before it is passed to the UPI generation module.

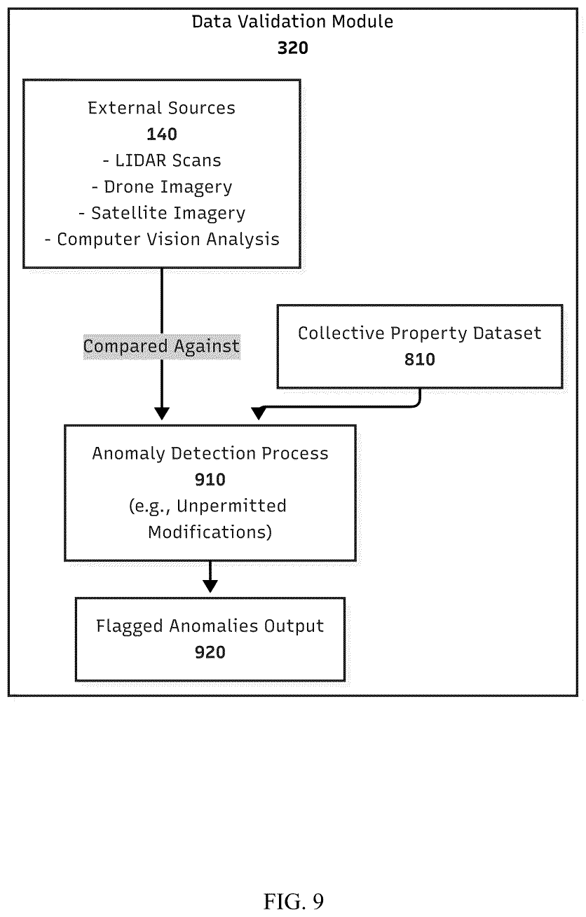

Turning now to FIG. 9, provided is a detailed view of the anomaly detection logic, another function operating within the data validation module 320. This process is designed to enhance data integrity by comparing the system's recorded information against real-world, often visual, data to identify significant physical changes or discrepancies that may not be documented in official records.

The process utilizes two main inputs. The first is the collective property dataset 810, which contains the property's known characteristics, legal status, and lifecycle events as recorded by the system from sources like deeds, permits, and user submissions. The second input comes from various external sources 140. These sources provide data that reflects the current physical state of the property. Examples shown include LIDAR Scans which provide precise three-dimensional measurements of the property and its structures; drone imagery which offers high-resolution, tip-close aerial photographs or videos; satellite imagery which provides broader, regularly updated overhead views of the property and its surroundings; and computer vision analysis which represents the application of artificial intelligence models to analyze the visual data from these imagery sources to automatically identify objects, changes, and features.

The core of the anomaly detection process 910 involves a systematic comparison between the recorded information in the collective property dataset 810 and the physical evidence gathered from the external sources 140. The primary goal of this process is to identify anomalies, with a key example being the detection of unpermitted modifications. For instance, the system might use computer vision analysis to identify a new swimming pool in recent satellite imagery that does not correspond to any permit found in the permit history within the collective property dataset. Such a discrepancy would be identified as a significant anomaly.

The final output of this process is the flagged anomalies output 920. When the anomaly detection process 910 identifies such a discrepancy, it flags the issue. This flag does not necessarily resolve the anomaly but serves as a critical piece of metadata. It can be used to lower the property's overall confidence score, trigger a notification for manual review by a human expert, or be included as a disclosure in any data packet generated for the property, thereby ensuring a more complete and transparent property record.

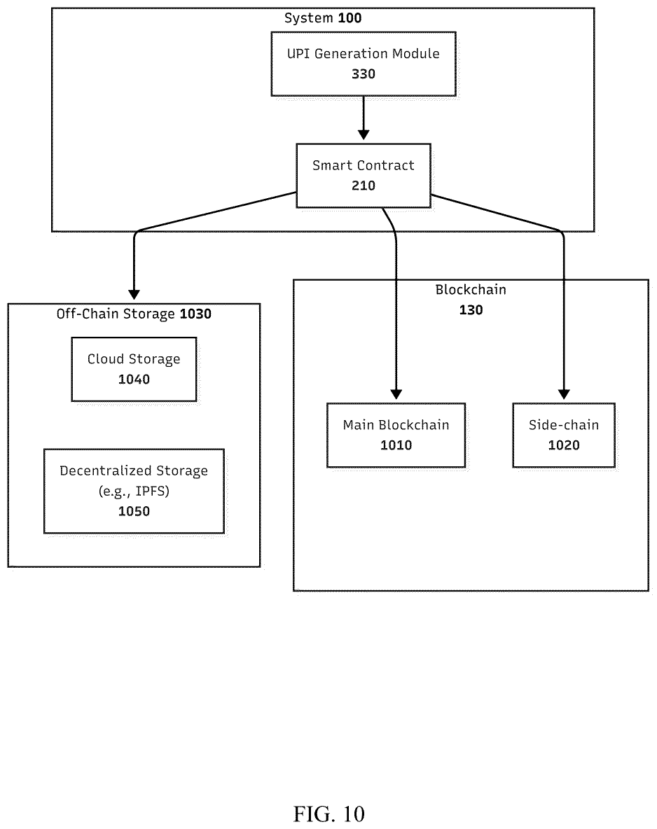

Turning now to FIG. 10, shown is a detailed illustration of the data recordation and storage layer of the system 100. This architecture is designed to leverage the security and immutability of blockchain technology while accommodating the practical requirements of storing large and varied datasets associated with real estate properties.

Within the main system 100, the UPI generation module 330, after creating the universal property identifier and processing the validated dataset, interacts with the smart contract 210. The smart contract 210 acts as a central distribution and logic hub, determining where and how different types of data are stored. The smart contract 210 interfaces with two distinct storage paradigms: on-chain storage, represented by the blockchain 130 block, and off-chain storage 1030. The blockchain 130 block represents the decentralized ledger technology used for recording the most critical and essential data. In one embodiment, the blockchain architecture may be multi-layered to enhance scalability and reduce transaction costs. It can comprise a main blockchain 1010, which could be a highly secure public blockchain (such as Ethereum) used to anchor the primary UPI and critical ownership or lifecycle events. It can also include one or more side-chains 1020, which are auxiliary blockchains connected to the main chain. Side-chains can be used to handle more frequent, lower-cost transactions or to comply with specific jurisdictional data residency requirements. The smart contract 210 is configured to write data to either or both the main blockchain 1010 and the side-chain 1020 as dictated by the system's logic.

Simultaneously, the smart contract 210 is configured to manage data stored in off-chain storage 1030. This approach is used because storing large files, such as high-resolution images, inspection videos, or extensive legal documents, directly on a blockchain can be prohibitively expensive and inefficient. Instead, the smart contract 210 stores a reference, or pointer (such as a cryptographic hash), to these large files on the blockchain, while the files themselves are stored off-chain. This off-chain storage can include traditional cloud storage 1040 (e.g., servers managed by a centralized provider) or decentralized storage 1050. Decentralized storage solutions, such as the InterPlanetary File System (IPFS), distribute files across a peer-to-peer network, offering enhanced resilience and censorship resistance. By employing this hybrid on-chain and off-chain model, the system architecture shown in FIG. 10 achieves a balance between the high security and verifiability of blockchain for core data and the efficiency and cost-effectiveness of off-chain solutions for storing large associated files.

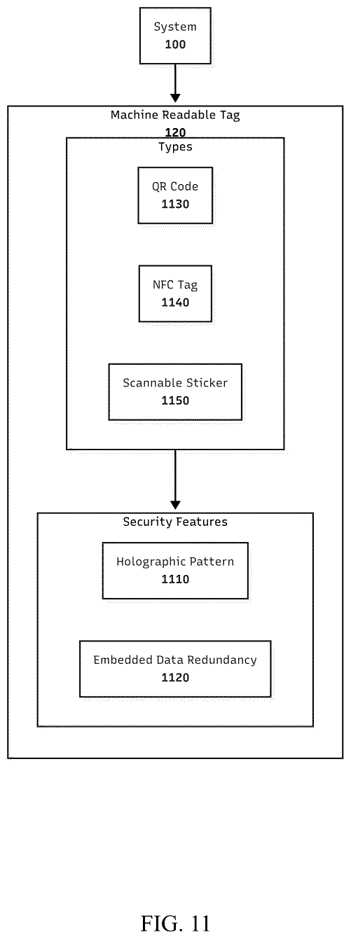

Turning now to FIG. 11, shown a detailed illustration of the machine readable artifact or tag 120, which is a primary physical or digital output of the system 100. This tag serves as the critical interface between the physical real estate asset and its corresponding digital identity stored on the blockchain. The system 100 generates this tag after the property data has been validated and the universal property identifier (UPI) has been created.

The diagram shows that the machine readable artifact or tag 120 can be realized in several different Types, providing flexibility for various use cases and applications. These types include QR Code 1130 which is a two-dimensional matrix barcode. This type of tag is visually scannable using standard cameras found on smartphones and other mobile devices, making it highly accessible to a broad range of users, including property owners, agents, inspectors, and potential buyers. NFC Tag 1140 which is a Near Field Communication (NFC) tag. This type of tag enables short-range wireless communication. A user can tap an NFC-enabled device to the tag to initiate the data retrieval process, offering a quick and convenient method of access without the need for a camera. Scannable Sticker 1150 represents the physical embodiment of the tag, designed for practical application. It is typically an adhesive sticker that can be affixed directly to the physical property, for instance, on a utility box, window, or inside a document folder. This sticker would contain one of the machine-readable technologies.

In addition to its form, the machine readable artifact or tag 120 is enhanced with security features to ensure its authenticity, integrity, and durability. As indicated by the arrow flowing from the “Types” block to the “Security Features” block, these features are applied to the chosen tag type. These features include holographic pattern 1110 which is a visual security measure where a holographic overlay or pattern is integrated into the physical tag (such as the sticker). This makes the tag difficult to counterfeit or fraudulently replicate, providing a quick visual method for a user to verify its authenticity. Embedded data redundancy 1120 is a technical security feature that ensures the tag remains functional even if it sustains partial physical damage. For a QR code, this is achieved by implementing high levels of error correction, which allows the code to be successfully scanned even if a portion of it is scratched, smudged, or otherwise obscured. This redundancy ensures the longevity and reliability of the tag in real-world conditions.

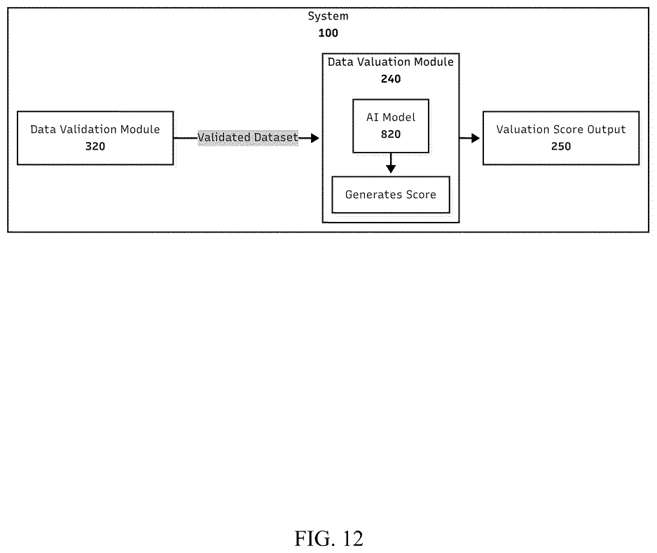

Turing now to FIG. 12, shown is a detailed illustration of the functionality of the valuation module 240, which is an analytical component of the main system 100. This module is responsible for computing a dynamic, data-driven valuation or health score for a real estate property, providing a quantitative assessment of its condition, risk, or market value. The process begins with the data validation module 320 (shown here for context as the source of the input data). As previously described, this module is responsible for processing all raw property data and producing a clean, normalized, and verified validated dataset. This high-integrity dataset, which represents the most accurate and comprehensive picture of the property available to the system, serves as the primary input for the valuation module 240.

The validated dataset is passed from the data validation module 320 to the valuation module 240. Within the valuation module 240, an AI model 820 is utilized to perform the sophisticated analysis required for valuation. This AI model is specifically trained to assess the comprehensive property information contained within the validated dataset. It is configured to weigh a multitude of factors, which can include the property's physical characteristics (e.g., square footage, number of rooms), location data, permit history, recent repairs or other lifecycle events, market trends, and any flagged anomalies or confidence scores associated with the data.

The AT model 820 processes this complex set of inputs and generates a score. The output of this analytical process is the valuation score output 250. This score is typically a normalized, quantitative value (for example, on a scale of 1-100) that represents the property's overall condition, risk profile, or estimated market value at that point in time. Because this score is directly derived from the system's live, validated dataset, it can be dynamically updated whenever new lifecycle events are recorded, providing users with a near-real-time assessment. This valuation score output 250 can then be stored and presented to authorized users via the system's interface module, serving as a critical tool for stakeholders like lenders, insurers, and investors.

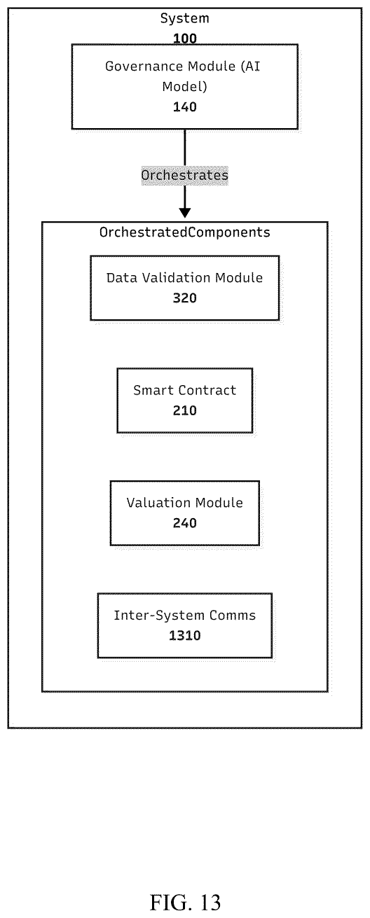

Turning now to FIG. 13, provided is a detailed illustration of the functionality of the governance module 140, which is an advanced, intelligent component of the main system 100. This module functions as a central control and orchestration engine, dynamically managing and directing the activities of various other parts of the system based on real-time data, system events, and predefined rules. In a preferred embodiment, the governance module 140 is implemented as an artificial intelligence (AI) model.

The governance module 140 resides within the system 100 and orchestrates a collection of orchestrated components. This orchestration involves monitoring the state of the system and triggering specific actions or workflows in the components it oversees. These orchestrated components include the data validation module 320; the governance module 140 can initiate a re-validation process within this module. For example, if the governance module receives an external alert about a change in zoning laws for a particular area, it can trigger the data validation module 320 to re-run its compliance checks for all affected properties. With regard to the smart contract 210, the governance module 140 can interact with the smart contract 210 to manage lifecycle events. For instance, upon detecting that a repair permit has been successfully closed (via an external data feed), the governance module can instruct the smart contract 210 to record this “repair completed” event on the blockchain. The governance module 140 can trigger a recalculation of a property's valuation. For example, after a “repair completed” event is logged by the smart contract, the governance module 140 can instruct the valuation module 240 to generate an updated valuation score that reflects the positive impact of the completed repair. Inter-system comms 1310 component represents the system's external communication interfaces (e.g., APIs, notification services). The governance module 140 orchestrates these communications. For example, after an updated valuation score is generated, the governance module 140 can use the inter-system comms 1310 component to send an automated alert to the property owner or a notification to a lender's system.

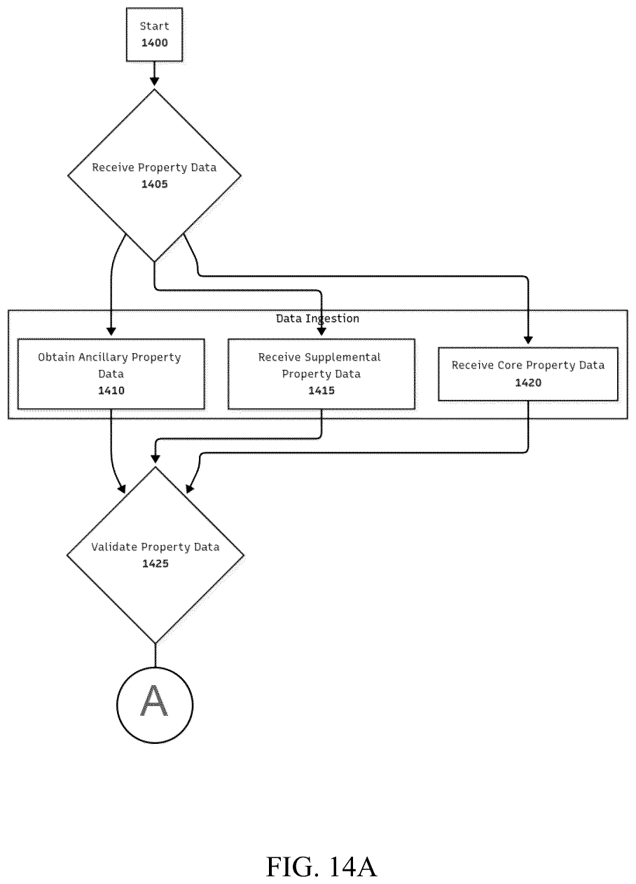

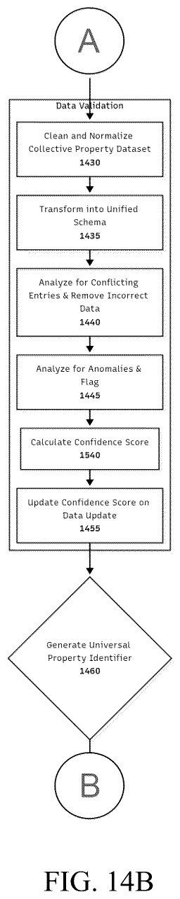

Turning now to FIG. 14A, shown is a flowchart illustrating the overall computer-implemented method for generating and managing a unified property identifier and its associated lifecycle record, in accordance with one embodiment. The diagram details the sequence of operations from initial data ingestion through validation, identifier generation, recordation, and data presentation, including optional advanced modules. The process begins at Start 1400. The initial phase of the method is to receive property data 1405. This phase involves gathering a comprehensive set of information about a specific real estate asset. This step comprises several concurrent or sequential sub-steps for gathering different categories of data: receive core property data 1420 (e.g., APN, GIS ID), receive supplemental property data 1415 (e.g., user-submitted inspection reports, appraisals), and obtain ancillary property data 1410 (e.g., public records, MILS data, sensor feeds).

Once the data is ingested, the method proceeds to validate property data 1425. This phase ensures the integrity and accuracy of the collected information through a series of sequential sub-steps. Turning now to FIG. 14B, the data validation process begins by taking the various inputs and creating a clean and normalize collective property dataset 1430. The normalized data is then used to transform into unified schema 1435, ensuring all data is in a consistent format for processing. The method then proceeds to analyze for conflicting entries and discard incorrect data 1440, where the system cross-references data points and removes those determined to be erroneous. Subsequently, it will analyze for anomalies and flag 1445, identifying and flagging unusual patterns or undocumented physical changes to the property. Based on these analyses, the method will calculate confidence score 1540 to represent the overall reliability of the data. Finally, the system is configured to update confidence score on data update 1455, ensuring the score remains current as new information is processed. After validation, the method moves to generate universal property identifier 1460.

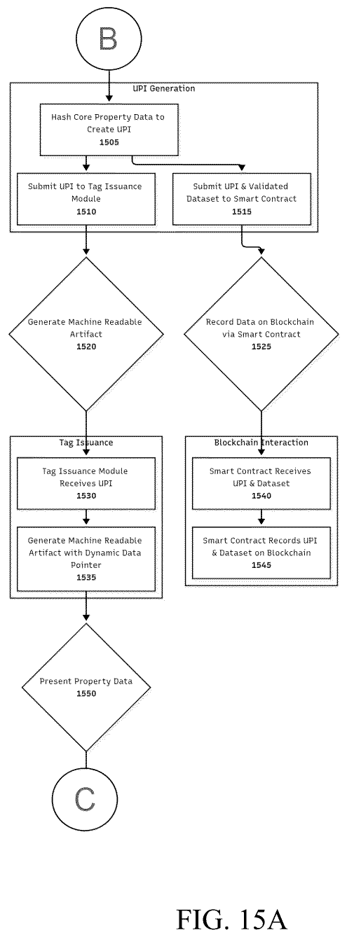

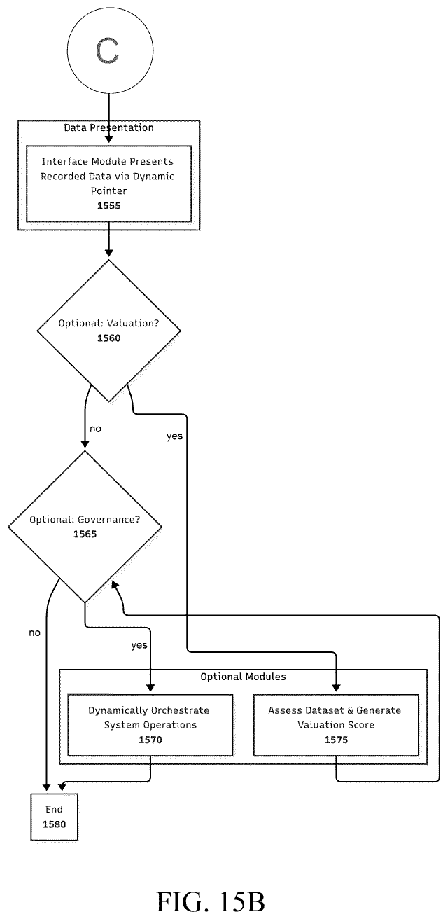

Turning now to FIG. 15A, within the UPI generation phase, the first step is to hash the core property data 1505 to create the unique and immutable UPI Following the creation of the UPI, two key actions occur: the system will submit the UPI to the tag issuance module 1510 and concurrently submit the UPI and validated dataset to the smart contract 1515. This leads to two parallel processes. The first is to generate the machine readable artifact or tag 1520. Within this tag issuance block, the tag issuance module receives the UPI 1530, and then proceeds to generate the machine readable artifact with a dynamic data pointer 1535. The second parallel process is to record data on the blockchain 1525. Within this blockchain interaction block, the smart contract receives the UPI and dataset 1540 and then executes to smart contract records UPI and dataset on the blockchain 1545.

Once the machine-readable artifact is generated and the data is recorded on the blockchain, the method enables present property data 1550. Turning now to FIG. 15B, in this data presentation step, an interface module presents recorded data via dynamic pointer 1555, allowing authorized users to access the verified property information by scanning the tag.

Following the core processing, the method includes several optional decision points and modules. At decision point Optional: Valuation?1560, if the system is configured for valuation, the method proceeds to the optional modules block, where it will assess the dataset and generate a valuation Score 1575. Whether or not valuation is performed, the method flows to the next decision point. At decision point Optional: Governance?1565, if the system is configured with the governance module, the method proceeds to dynamically orchestrate system operations 1570 within the optional modules block. This step involves the high-level AI-driven management of system workflows. After any optional steps are completed, the process concludes at End 1580.

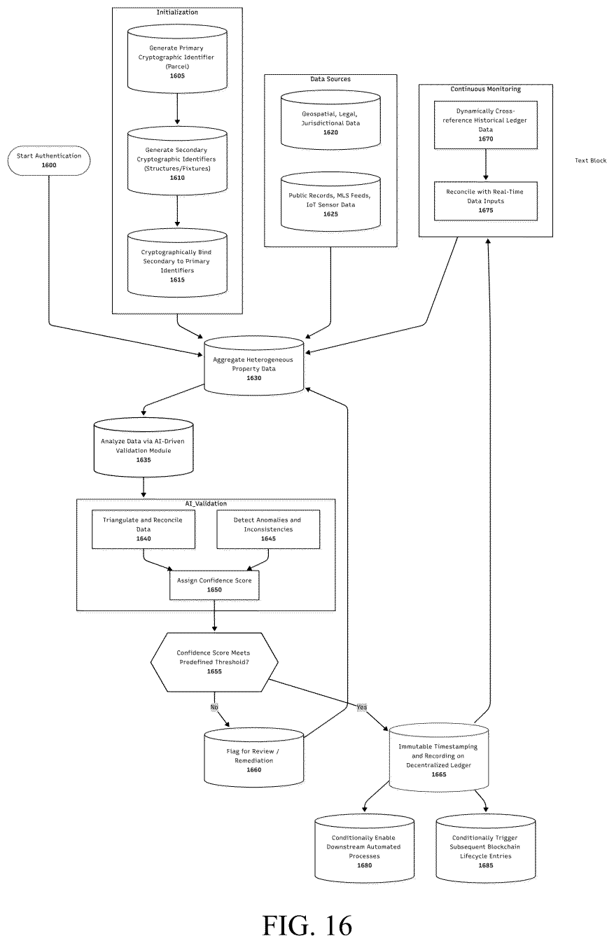

Turning now to FIG. 16, illustrated is a flowchart detailing a method for continuously authenticating the state of physical real estate assets throughout their lifecycle. The process commences at Start Authentication 1600. The authentication process may be initiated by establishing a foundational digital identity for the asset. This initialization phase involves generating a primary cryptographic identifier 1605 for the real estate parcel. Subsequently, one or more secondary cryptographic identifiers 1610 are generated for associated physical structures or fixtures. These secondary identifiers are then cryptographically bound to the primary identifier 1615, creating a foundational digital representation of the asset.

Following initialization, the method proceeds to the aggregation of heterogeneous property data 1630. This aggregation involves ingesting data from the established cryptographic identifiers 1615, as well as a plurality of disparate data sources. In some embodiments, these sources include geospatial, legal, and jurisdictional data 1620. In other embodiments these sources can also comprise public records, multiple listing service (MLS) feeds, and data from internet-of-things (IoT) sensors 1625.

The aggregated data is subsequently analyzed via an AI-driven validation module 1635. This module is configured to execute several AI validation operations. It triangulates and reconciles data 1640 by comparing and harmonizing data points from the various sources. Concurrently, the module functions to detect anomalies and inconsistencies 1645, identifying potential errors within the dataset. Based on this comprehensive analysis, the module assigns a confidence score 1650, which quantifies the authenticity and completeness of the aggregated property data.

A decision point 1655 evaluates whether the assigned confidence score meets a predefined data authenticity threshold. If the threshold is not met, the data is flagged for review or remediation 1660. This prevents inaccurate information from being recorded, and the process may return to the aggregation phase 1630 for the inclusion of updated or corrected data.

If the confidence score meets or exceeds the threshold, the authenticated, confidence-scored state of the real estate asset undergoes immutable timestamping and recording on a decentralized ledger 1665. This successful validation serves as a gatekeeper for further actions. Downstream automated processes are conditionally enabled 1680 only upon this confirmation. Subsequent blockchain-based lifecycle entries are also conditionally triggered 1685 only when this predefined threshold is met.

The system ensures the data remains current through continuous monitoring. This involves dynamically cross-referencing the historical lifecycle data recorded on the decentralized ledger 1670 and reconciling it with real-time data inputs 1675. This continuous input loops the process back to the aggregation 1630 and validation stages, ensuring the asset's recorded state remains current and validated.

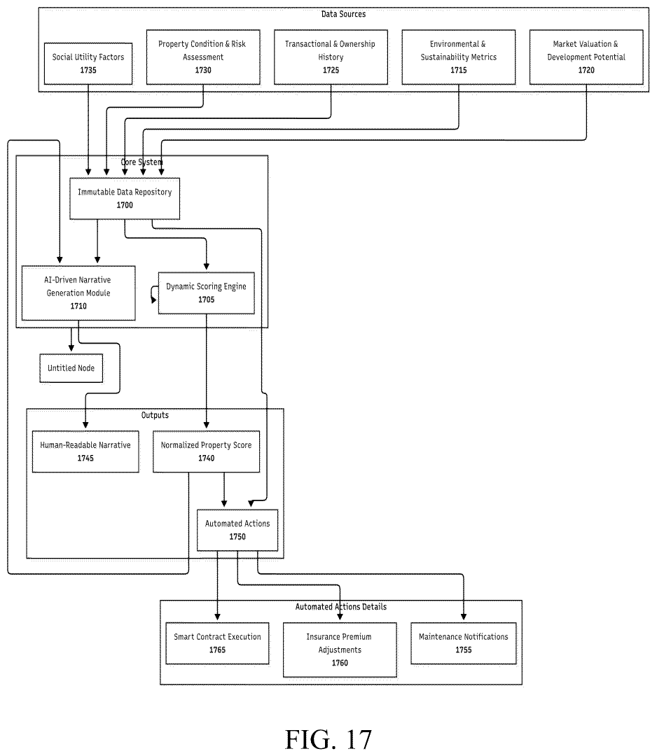

Turning now to FIG. 17, shown is an embodiment of a system architecture configured to generate and maintain a comprehensive, continuously updated profile for a real estate property. The system architecture centers around a core system that ingests data from a plurality of data sources. At the core is the immutable data repository 1700, which is configured to act as a secure, unchangeable log for all information pertaining to a specific property, identified by a universal property identifier. The immutable data repository 1700 aggregates lifecycle metadata from diverse external sources. In one embodiment, these sources include some combination of: environmental & sustainability metrics 1715, comprising information on a property's environmental impact and sustainability features; market valuation & development potential 1720, comprising data related to market trends and opportunities for future development; transactional & ownership history 1725, comprising records of permits, inspections, title transfers, liens, and insurance activity; property condition & risk assessment 1730, comprising data on structural integrity, maintenance history, and safety systems; and social utility factors 1735, comprising metrics on community impact and other public records.

The lifecycle metadata aggregated within the immutable data repository 1700 is subsequently processed by a dynamic scoring engine 1705. The dynamic scoring engine 1705 retrieves this metadata and processes it by aggregating weighted factors derived from the various data inputs. This engine 1705 utilizes a composite scoring model that evaluates not only the current state of the property but also considers its future potential by incorporating identifiers for existing assets and possible developments. The dynamic scoring engine 1705 is configured to calculate and, upon the introduction of new data into the repository 1700, recalibrate a score in real-time.

In conjunction with the scoring process, the core system includes an AI-driven narrative generation module 1710. This module 1710 synthesizes data directly from the immutable data repository 1700 and further synthesizes the score calculated by the dynamic scoring engine 1705. Utilizing natural language processing (NLP), the module 1710 translates the complex underlying data and the property score into a clear, coherent summary. The module 1710 is configured to generate and update this narrative in real-time whenever the score or underlying data changes.

The system produces several outputs. The dynamic scoring engine 1705 outputs the normalized property score 1740, a standardized assessment of the property. The AI-driven narrative generation module 1710 outputs the human-readable narrative 1745, detailing the property's history and current condition. When the dynamic scoring engine 1705 determines that underlying data meets predefined thresholds, or when the normalized property score 1740 crosses specific thresholds, the system is configured to trigger automated actions 1750. In some embodiments, these automated actions 1750 can initiate various downstream processes, such as issuing maintenance notifications 1755, implementing insurance premium adjustments 1760, or initiating smart contract execution 1765.

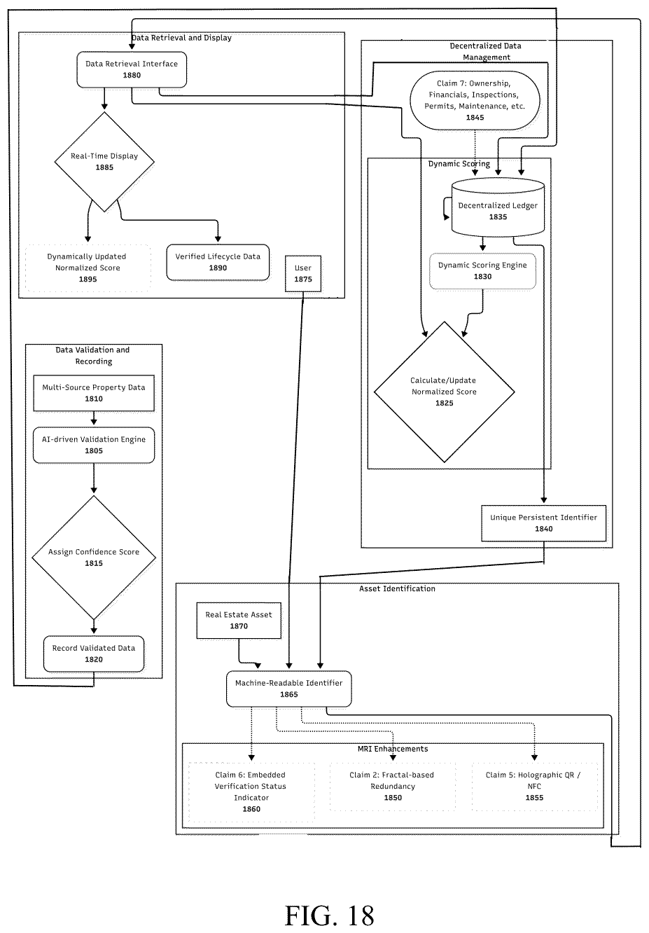

Turning now to FIG. 18, the process is initiated by receiving multi-source property data 1805 from various originators. This data is then processed by an AI-driven validation engine 1810, which is configured to rigorously validate the accuracy and authenticity of the incoming information. Upon validation, the engine assigns a confidence score 1815 to the data before it is permanently recorded, ensuring a foundational layer of data integrity from the point of entry.

Following the assignment of a confidence score, the validated data is recorded 1820 onto a decentralized ledger 1825. This ledger serves as a secure and immutable repository for the information. The system facilitates decentralized data management 1830, storing the complete, verified lifecycle data of a given real estate asset 1865. In some embodiments, this lifecycle data may include, but is not limited to, critical records such as ownership history, financial records, inspection reports, maintenance logs, permits, disclosures, and valuations 1835. All records stored on the ledger are linked to a universal property identifier 1840 that is specific to that property.

The real estate asset 1865 is physically or digitally associated with a machine readable artifact or tag 1845. This machine readable artifact 1845 serves as a representation of the asset's universal property identifier 1840, acting as a key to bridge the physical asset with its digital record on the decentralized ledger 1825. A user 1875 can scan the machine readable artifact 1845 to activate a data retrieval and display interface 1870. Upon activation, the interface 1870 fetches the corresponding verified lifecycle data 1890 from the decentralized ledger 1825 via the universal property identifier. The system is configured for the real-time display 1880 of this verified data 1890 to the user 1875.

In another embodiment, the system may include a dynamic scoring engine 1830 configured to continuously analyze the verified lifecycle data stored on the decentralized ledger 1825. Through a process of weighted analysis, this engine calculates and updates a normalized score 1895 representing the property's current condition and value. When a user 1875 accesses the data retrieval interface 1870 by scanning the machine readable artifact 1845, the interface is configured to optionally fetch and display this dynamically updated normalized score 1895, offering an instant, data-backed assessment of the asset.

To enhance security, durability, and usability, the machine readable artifact 1845 may be implemented with several advanced features. In one embodiment, the machine readable artifact incorporates a fractal-based redundancy structure 1850, wherein individual fragments or pixel cells of the identifier independently contain the comprehensive data and metadata, allowing the identifier to be read even if partially damaged. In another embodiment, the machine readable artifact is implemented using advanced physical formats, such as a holographically enhanced QR code or a Near Field Communication (NFC) element 1855. Furthermore, the machine readable artifact can be configured to visually embed an indicator 1860 that reflects the asset's latest verification status, providing an immediate visual cue of authenticity to the user 1875.

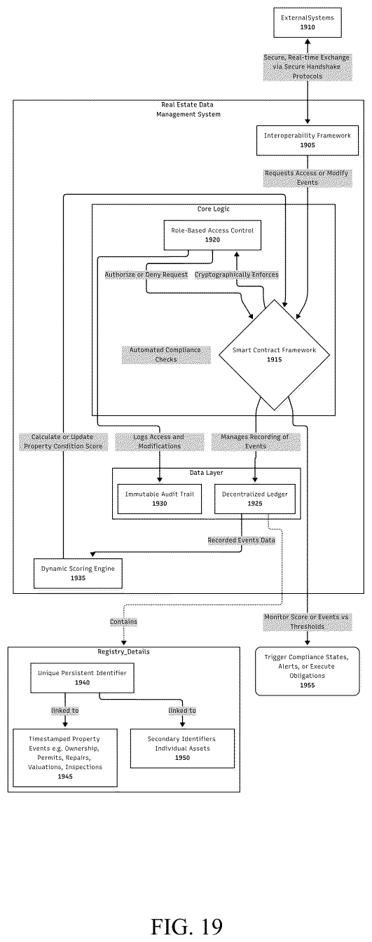

Turning now to FIG. 19, illustrated is a schematic diagram of an embodiment of the real estate data management system which interfaces with various external systems 1910, which in some embodiments may include municipal government databases, title and escrow platforms, insurance provider systems, and lending institution networks. Communication between the system and these external systems 1910 is facilitated by an interoperability framework 1905. This framework comprises an API layer configured to manage secure, real-time data exchange utilizing secure handshake protocols. The interoperability framework 1905 receives requests from external entities to access existing data or record new property events.

Requests processed by the interoperability framework 1905 are directed to the system's core logic, primarily governed by the smart contract framework 1915. The smart contract framework 1915 provides the logic layer that defines the rules and processes for managing the lifecycle registry. Before any request is executed, it is subject to verification by the role-based access control 1920 mechanism. The role-based access control 1920 dynamically manages permissions, determining whether to authorize or deny the request based on the requester's credentials. The smart contract framework 1915 cryptographically enforces the rules defined by the role-based access control 1920. The smart contract framework 1915 executes automated compliance checks on incoming event data, verifying it against predefined regulatory rules before allowing the data to be recorded.

Once a request is authorized and validated, the smart contract framework 1915 manages the recording of the events into the data layer. The foundation of the data layer is the decentralized ledger 1925, which maintains the immutable lifecycle registry. This ledger ensures that once event data is recorded, it cannot be altered. Concurrently, all access attempts and modifications are logged in an immutable audit trail 1930, providing a complete and tamper-proof history of interactions with the registry.

The data structure within the registry, detailed in the registry details, is organized around a universal property identifier 1940 assigned to each real estate asset. Linked to this universal property identifier 1940 are Timestamped Property Events 1945, which comprise a comprehensive history including, but not limited to, ownership transfers, title changes, permits, repairs, valuations, and inspections. To enable granular tracking, the universal property identifier 1940 may also be linked to one or more secondary identifiers 1950, representing individual assets associated with the property (e.g., HVAC systems or roofing).

The system further incorporates advanced analytical capabilities through a dynamic scoring engine 1935. This engine is configured to automatically calculate or update a “property condition score” by analyzing the recorded events data retrieved from the decentralized ledger 1925. The smart contract framework 1915 continuously monitors this property condition score and specific recorded events against predefined thresholds. If a threshold is met (e.g., a score drops below a critical level or a violation is recorded), the smart contract framework 1915 is configured to automatically trigger compliance states, alerts, or execute obligations 1955, such as notifying stakeholders or executing predefined contractual actions.

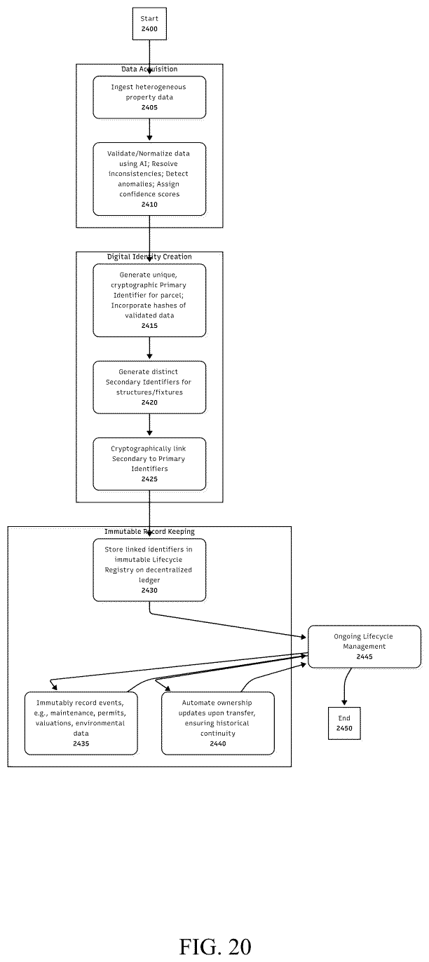

Turning now to FIG. 20, illustrated is a flowchart of a computer-implemented method for establishing a persistent, unique, and immutable digital identity for real estate assets, which may include physical land parcels and their associated structures or fixtures. The process commences at step 2400 and is structured into three primary phases: data acquisition and verification, digital identity creation, and immutable record keeping and management.

The method begins with the data acquisition phase. At step 2405, an automated data ingestion engine is employed to ingest heterogeneous property data. This data pertains to a physical parcel and its associated structures and is collected from a plurality of disparate data sources. Following ingestion, the data proceeds to step 2410, where it is processed by an artificial intelligence (AI) module. This AI module is configured to validate and normalize the ingested data, resolve any inconsistencies, detect anomalies within the dataset, and assign data authenticity confidence scores.

Upon successful verification of the data, the digital identity creation phase is initiated. At step 2415, the system generates a unique, cryptographically secured primary identifier for the physical parcel, a universal property identifier. To ensure data integrity, this universal property identifier incorporates hashes of the validated data from step 2410. Subsequently, at step 2420, one or more distinct secondary identifiers are generated for the associated structures or fixtures located on the parcel. At step 2425, these secondary identifiers are cryptographically linked to the primary identifier, thereby establishing a verifiable and immutable relationship between the parcel and its components.

The final phase involves immutable record keeping and management. At step 2430, the linked primary and secondary identifiers are stored in an immutable lifecycle registry. This registry is maintained on a decentralized ledger system, which serves to anchor the digital identity of the asset. The system is configured for on-going lifecycle management 2445. This includes step 2435, where subsequent property lifecycle events associated with the linked identifiers—such as maintenance records, permits, ownership changes, valuations, or environmental data—are immutably recorded in the registry. Concurrently, at step 2440, the system utilizes smart contract execution to automate the update of ownership records associated with the primary identifier upon property transfer, ensuring the continuity of the historical record in the lifecycle registry. The process concludes at step 2450.

Turning now to FIG. 20, shown is a block diagram illustrating an example system platform 100 that may be used to implement one or more of the disclosed embodiments. For example, system platform 100 may be used as or in conjunction with the functions, processes, or methods described herein, and may represent the hardware components of the system platform 100, user systems 2140, or external systems described in other figures. System platform 100 can be a server, a personal computer, a mobile device, or any other processor-enabled device capable of data communication. The system platform 100 comprises several major subsystems, including Processing and Memory, Storage and Network, and Input-Output Devices. These subsystems are communicatively coupled via a central bus 2010.

The Processing and Memory subsystem includes one or more processors 2015 for executing instructions, a main memory 2020 that provides storage for instructions and data for programs executing on the processor 2015, and a static memory 2025. Main memory 2020 is typically a volatile, semiconductor-based memory such as dynamic random access memory (DRAM) or static random access memory (SRAM). Static memory 2025 is typically a non-volatile memory, such as read-only memory (ROM), for storing firmware or other instructions that persist when the system is powered off. The processor 2015, main memory 2020, and static memory 2025 are interconnected via the bus 2010.

The Storage and Network subsystem includes a computer-readable medium 2050 and a network interface device 2055. The computer-readable medium 2050 is a non-transitory medium, such as a magnetic hard disk, a solid-state drive (SSD), or other forms of secondary memory, used for long-term storage of data and computer-executable code. The network interface device 2055, which may be a network interface card (NIC), a modem, or a wireless adapter, allows the system platform 100 to communicate with external devices and systems over a network 2060.

The Input-Output Devices subsystem provides interfaces for user interaction and for presenting information. This subsystem can include a video display 2030 (e.g., an LCD or LED monitor), an alphanumeric input device 2035 (e.g., a keyboard), a cursor control device 2040 (e.g., a mouse, trackball, or touchpad), and a signal generation device 2045 (e.g., a speaker or haptic feedback motor). These devices are connected to the other components of the system platform 100 via the bus 2010, allowing the processor 2015 to receive input and send output.

The bus 2010 represents one or more communication buses or data channels that facilitate information transfer between the various components of the system platform 100. The bus 2010 may include a data bus, an address bus, and a control bus, and can be implemented using any standard or non-standard bus architecture, such as PCI, USB, or others.

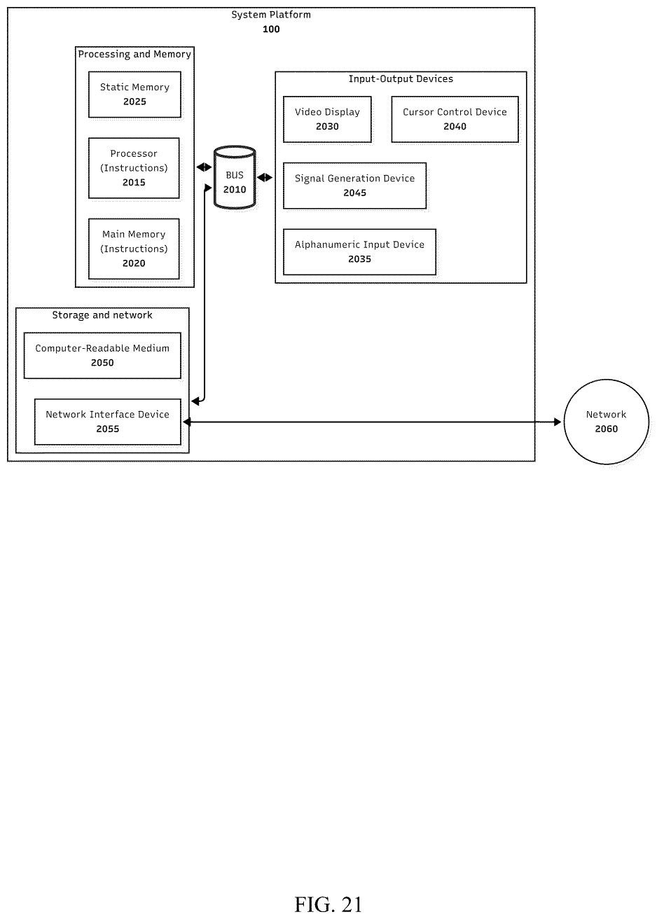

Turning now to FIG. 21 which illustrates an example infrastructure in which one or more of the disclosed processes may be implemented, according to an embodiment. The infrastructure comprises a system platform, one or more user systems, and one or more external systems 2130, which are all communicatively connected via a network 2060. The system platform 100 may be implemented using the hardware architecture described above.

The system platform hosts an application 2110 and a database 2120. Application 2110 may comprise one or more server-side software modules that implement the backend processes, methods, and functionality described herein. Database 2120 provides persistent storage for data used by the application 2110, such as user data, system configurations, and other operational data. The system platform communicates bidirectionally with the network 2060 to interact with other connected systems.

User systems may comprise any type of computing device, such as a desktop computer, laptop, or mobile device, and may be implemented using the hardware described in above. Each user system may execute its own application 2140, which can be a client application (e.g., a web browser or a dedicated mobile app) that provides a user interface for interacting with the application 2110 on the system platform. The connection between user systems 2140 and the network 2060 is bidirectional, allowing for requests to be sent to the system platform 100 and for data to be received in response.

The network 2060 may comprise the Internet, a local area network (LAN), a wide area network (WAN), or any combination thereof. Communication across the network 2060 may use standard protocols such as TCP/IP, HTTP, and HTTPS. The infrastructure may also include one or more external systems 2130, which could be third-party platforms, services, or data sources that interact with the system platform. For example, the application 2110 may query an external system 2130 for data via an API call over the network 2060.

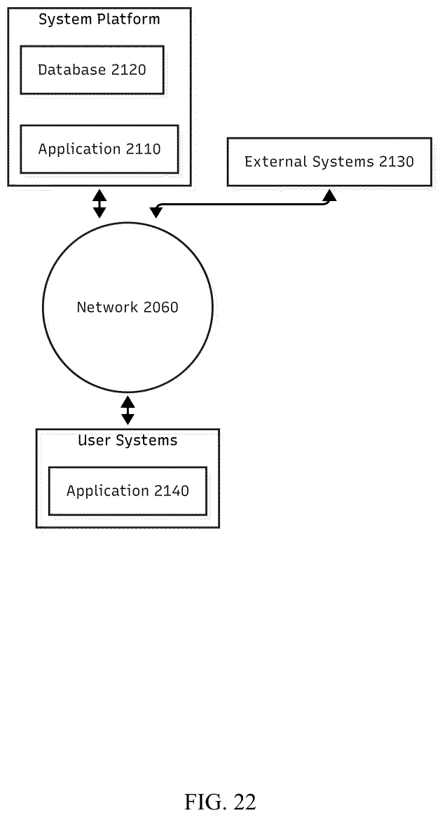

Turning now to FIG. 22 which illustrates another example infrastructure in which one or more of the disclosed processes may be implemented, according to an embodiment. This infrastructure integrates a blockchain 2210 as a core component. The architecture includes a system platform 100 and one or more user systems 2140, both communicatively connected via a network 2060 to each other and to the blockchain 2210.

The system platform 100, which can be implemented using the hardware components detailed in above, contains a database 2120. The system platform 100 interacts with the network 2060 to both serve the user systems 2140 and to communicate with the blockchain 2210. For instance, the system platform 100 may read data from or write transaction data to the blockchain 2210. The connection between the system platform 100 and the network 2060 is bidirectional.

User systems 2140 allow users to interact with the system platform 100 and, by extension, the blockchain 2210. The user systems 2140 connect to the network 2060 to send requests and receive data. The network 2060 acts as the communication layer connecting all entities. A feature of this architecture is the blockchain 2210, which may be a public or private distributed ledger. The system platform 100 and user systems 2140 can leverage the blockchain 2210 for purposes such as secure, immutable data recording, asset tracking, or executing smart contracts. The directional arrows indicate that data flows from the system platform 100 through the network 2060, with some of this data being directed to the blockchain 2210 for processing and storage.

The present technology may be described in the general context of computer-executable instructions stored on computer readable medium that may be executed by a computer. However, one embodiment of the present technology may also utilize a distributed computing environment where tasks are performed remotely by devices linked through a communications network.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A computer-implemented method for generating a persistent, unique, and immutable digital identity for real estate assets, comprising:
ingesting heterogeneous property data related to a physical parcel and its associated structures or fixtures from a plurality of disparate data sources via an automated data ingestion engine comprising a data normalization pipeline executing on one or more processors;
validating and normalizing the ingested data using an artificial intelligence module comprising a trained machine learning model configured to resolve inconsistencies, detect anomalies within the ingested data, and assign data authenticity confidence scores indicating completeness and consistency of the ingested data;
generating a unique, cryptographically secured primary identifier for the physical parcel, the primary identifier comprising a cryptographic hash of validated parcel attributes;
generating one or more distinct secondary identifiers for the associated structures or fixtures;
cryptographically linking the secondary identifiers to the primary identifier by computing, for each secondary identifier, a cryptographic binding between the secondary identifier and the primary identifier, the binding establishing a verifiable and immutable relationship between the physical parcel and its associated structures or fixtures;
storing the linked identifiers in an immutable lifecycle registry maintained on a decentralized ledger system.

2. The method of claim 1, wherein the primary identifier incorporates hashes of the validated parcel attributes and is anchored to the decentralized ledger system.

3. (canceled)

4. (canceled)

5. The method of claim 1, further comprising immutably recording subsequent property lifecycle events associated with the linked identifiers in the lifecycle registry.

6. The method of claim 5, wherein the property lifecycle events comprise at least one of: maintenance records, permits, ownership changes, valuations, or environmental data.

7. The method of claim 5, further comprising automating the update of an ownership record associated with the primary identifier upon property transfer via smart contract execution on the decentralized ledger, ensuring continuity of a historical record in the lifecycle registry.

8. A computer-implemented method for continuous lifecycle authentication of physical real estate assets, comprising:
aggregating heterogeneous property data from a plurality of disparate sources, including geospatial, legal, and jurisdictional data related to a real estate asset;
analyzing the aggregated data using an artificial intelligence (AI)-driven validation module comprising a trained machine learning model configured to:
triangulate and reconcile the data;
detect anomalies and inconsistencies; and
assign a confidence score to each data record indicating data authenticity and completeness;
immutably timestamping and recording the authenticated, confidence-scored state of the real estate asset on a decentralized ledger;
dynamically cross-referencing and reconciling historical lifecycle data recorded on the decentralized ledger with real-time data inputs to continuously monitor the asset's state; and
conditionally enabling downstream automated processes that write to the decentralized ledger only upon automated confirmation that the assigned confidence score meets or exceeds a predefined data authenticity threshold, such that any data record having an assigned confidence score below the predefined data authenticity threshold is blocked from triggering the downstream automated processes.

9. The method of claim 8, further comprising initiating the authentication by generating a primary cryptographic identifier for a real estate parcel and one or more secondary cryptographic identifiers for associated physical structures or fixtures, and cryptographically binding the secondary cryptographic identifiers to the primary cryptographic identifier.

10. The method of claim 8, wherein the heterogeneous property data includes data ingested from sources comprising at least one of public records, multiple listing service feeds, or internet-of-things sensor data.

11. The method of claim 8, further comprising conditionally triggering subsequent blockchain-based lifecycle entries on the decentralized ledger only when the predefined data authenticity threshold is met following validation by the AI-driven validation module, wherein blockchain-based lifecycle entries derived from data records having confidence scores below the predefined data authenticity threshold are prevented from being written to the decentralized ledger.

12. A computer-implemented system for dynamic real estate valuation and property intelligence, comprising:
an immutable data repository comprising a decentralized ledger configured to securely store lifecycle metadata associated with a universal property identifier for a real estate property;
a single dynamic scoring engine comprising a trained machine learning model executing on one or more processors, configured to aggregate a plurality of weighted factors derived from the lifecycle metadata, the factors comprising data related to each of:
property condition and risk assessment;
transactional and ownership history;
environmental and sustainability metrics; and
market valuation and development potential;
the dynamic scoring engine further configured to dynamically calculate and update a single normalized property score for the real estate property based on the aggregated weighted factors from each of the four recited data categories, recalibrating the single normalized property score in real-time as new data is received in the immutable data repository.

13. The system of claim 12, further comprising an artificial intelligence narrative generation module comprising a natural language processing model and operatively coupled to the dynamic scoring engine, configured to utilize natural language processing to automatically synthesize (ii the lifecycle metadata stored in the immutable data repository and ii the single normalized property score output by the dynamic scoring engine into a human-readable narrative summarizing a property's history and current condition.

14. The system of claim 12, wherein the property condition and risk assessment data comprises at least one of: structural integrity data, maintenance records, environmental risk assessments, or safety system status.

15. The system of claim 12, wherein the transactional and ownership history data comprises at least one of: permit history, inspection records, remodeling data, title transfers, liens, mortgages, or insurance activity.

16. The system of claim 12, wherein the weighted factors further comprise social utility factors, including community impact metrics and public records tied to verifiable outcomes.

17. The system of claim 12, wherein the dynamic scoring engine employs a composite scoring model that integrates the universal property identifier, secondary identifiers for existing physical assets, and at least one development identifiers representing potential future development of the real estate property, assigning weights to the development identifier based on development feasibility and economic factors.

18. The system of claim 12, wherein the dynamic scoring engine is further configured to transmit a signal to one or more external systems to trigger automated external actions when the normalized property score or an underlying lifecycle metadata attribute meets predefined thresholds.

19. The system of claim 18, wherein the automated external actions include at least one of G) generating and transmitting a maintenance notification to a property owner, ii transmitting data for insurance premium adjustments to an insurance provider system, or iii executing a smart contract on a decentralized ledger to record an action.

20. The system of claim 13, wherein the artificial intelligence narrative generation module is configured to dynamically update the human-readable narrative in real-time corresponding to each recalibration of the single normalized property score by the dynamic scoring engine.
